(19) United States
(12) Patent Application Publication
(10) Pub. No.: US 2008/0129950 A1
(43) Pub. Date: Jun. 5, 2008

(54) Repair method and apparatus therefor

(75) Inventor: Masahiro Abe, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/903,318

(22) Filed: Sep. 21, 2007

(30) Foreign Application Priority Data
Mar. 24, 2005 (JP) PCT/JP2005/005399

(51) Int. Cl. G02F 1/13; H01S 3/101

(52) U.S. Cl. 349/192; 372/26

(57) ABSTRACT

In the repair method and the apparatus, geometry data of a defective section is extracted from defect image data obtained by picking up an image of a defective section on a glass substrate 2; the angle of each the micromirror of a DMD unit 16 is controlled in high speed in accordance with the geometry data; and the cross-sectional shape of the laser light r reflected by these micromirrors are conformed substantially to the shape of the defective section to be illuminated to the defective section.

The present application is based on international patent application No. PCT/JP2005/005399, filed Mar. 24, 2005, in Japan, the content of which is incorporated herein by reference.

### BACKGROUND OF THE INVENTION

1. Field of the Invention

The present invention relates to a repair method and an apparatus therefor for repairing defective sections generated on, for example, glass substrates of liquid crystal displays (hereinafter called LCDs), semiconductor wafers, and printed circuit boards by laser light radiation.

2. Background Art

Various inspections are conducted for photo-lithographically-processed glass substrates in LCD manufacturing steps. If this results in finding defective sections in a resist pattern or an etching pattern formed on the glass substrates, the defective sections are repaired by radiating laser light thereonto.

Patent documents 1 and 2 disclose technologies of repair methods. Patent document 1 discloses emitting ultraviolet laser light oscillated by an ultraviolet laser oscillator into a variable rectangular opening; opening or closing the variable rectangular opening with movable knife edges; rectifying the cross-section of the ultraviolet laser light to a desirable rectangle; and radiating the rectified ultraviolet laser light onto defective sections.

Patent document 2 discloses a laser beam having a cross-section corresponding to that of a defective section by emitting a laser beam oscillated by a laser oscillator into an aperture and moving and rotating blades attached to the aperture. The aperture is adjustable corresponding to an arbitrary shape of a defective section by exchangeably combining a linear blade and a blade having semicircular notches and semicircular notches.

Patent document 1: Japanese Unexamined Patent Application, First Publication No. H9-5732
Patent document 2: Japanese Unexamined Patent Application, First Publication No. H3-13946

Repairs conducted in the LCD-manufacturing process are repairing resist patterns formed on glass substrates and repairing etching patterns. The resist-pattern repairing illuminates laser light onto defective sections in resist patterns formed on a metal layer formed on a glass substrate. In this repair method, laser light illuminated onto the defective section in the resist pattern sometimes reaches to the metal layer beneath the resist pattern. Laser light radiation by this method has little effect on the metal layer, thereby raising little concern of the laser-light-radiated metal layer becoming damaged.

In contrast, in the etching-pattern repairing, laser-light is radiated onto defective sections in a metal pattern etched on a glass substrate. Since the glass substrate is beneath the repaired metal layer, the laser light radiation onto the defective section in the metal pattern reaching the glass substrate therebeneath may damage the glass substrate. Since a once-damaged glass substrate is hardly amenable, scrapping the glass substrates inevitably reduces yield in LCD manufacturing. Therefore, there is a need for eliminating damage onto glass substrates.

In addition, defective sections to be repaired have such complex shapes varying from defect to defect, so they cannot be represented by a mere combination of linear lines. Since opening or closing the variable rectangular opening as disclosed by the Patent document 1 hardly conforms the cross-section of ultraviolet laser light to the shape of a defective section, the patterns or a layer therebeneath may be damaged by the ultraviolet laser light not radiated onto the defective section to be repaired.

The use of blades as disclosed by the Patent document 2 allows the cross-sectional shape of laser light to be rectified corresponding to an arbitrary shape of a defective section. However, not all the some defective sections cannot be attended to since their size and shape vary from defective section to defective section. In addition, repairing defective sections having different shapes necessitates exchanging blades in accordance with each shape of the defective section, thereby the repair work is time-consuming. In particular, requirements in LCD-manufacturing processes cannot be satisfied, i.e., reducing product yield in order to reduce production cost and shortening repairing time.

### SUMMARY OF THE INVENTION

Accordingly, it is an object of the present invention to provide a repair method and apparatus therefor that enable accurate and high-speed repair of defective sections by rectifying the cross-sectional shape of laser light to a complex shape of defective sections.

The present invention is a repair method including: emitting laser light output from a laser light source into an spatial modulator device having a plurality of modulator elements arranged in vertical and horizontal directions; rectifying the cross-sectional shape of the laser light to the shape of an object to be prepared with each modulator elements by controlling each modulator elements of the spatial modulator device; and repairing the repair object by illuminating the rectified laser light onto the repair object.

The present invention is a repair method including: extracting geometry data of a repair object based on image data; outputting laser light from a laser light source; rectifying the laser light output from the laser light source to the shape of the repair object by controlling each modulator element of the spatial modulator device having a plurality of each modulator elements based on geometry data of the repair object; and illuminating the laser light rectified by the modulator element to repair the repair object.

The present invention is a repair apparatus including: a laser light source for outputting laser light; spatial modulator device having a plurality of respectively controllable modulator elements arranged in vertical and horizontal directions; an image-pickup apparatus for picking up an image of the repair object; a repair-object-extracting unit for extracting geometry data of the repair object from the image data obtained by the image-pickup operation by the image-pickup apparatus; a laser-shape-control unit for rectifying the laser light so as to conform to the shape of the repair object by each modulator elements by controlling each modulator elements of the spatial modulator device based on geometry data of the repair object extracted by the repair-object-extracting unit; and an optical system for illuminating the laser light rectified by each modulator elements of the spatial modulator device onto the repair object.

The present invention can provide a repair method and apparatus therefor that enable high-speed repair for defective sections by rectifying the cross-sectional shape of laser light to a complex shape of each defective section.

### BRIEF DESCRIPTION OF DRAWINGS

FIG. 1 is a schematic view of a repair apparatus according to a first embodiment of the present invention.

FIG. 2 is a perspective view of a modulator element of a spatial modulator device for use in the repair apparatus according to the first embodiment of the present invention.

FIG. 3 is a diagram showing the arrangement of modulator elements in a spatial modulator device for use in the repair apparatus according to the first embodiment of the present invention.

FIG. 4 is a flowchart explaining operations carried out by the repair apparatus according to the first embodiment of the present invention.

FIG. 5 graphically shows defect image data captured by an image-pickup camera in the repair apparatus according to the first embodiment of the present invention.

FIG. 6 graphically shows reference image data for the repair apparatus according to the first embodiment of the present invention.

FIG. 7 graphically shows defect extraction image data extracted by the repair apparatus according to the first embodiment of the present invention.

FIG. 8A graphically shows an example of a non-repaired state of geometry data of defective section that is about to be repaired by a retouch section in the repair apparatus of the first embodiment of the present invention.

FIG. 8B graphically shows a repaired state of geometry data of the defective section shown in FIG. 8A that is repaired by the retouch section of the apparatus.

FIG. 9A graphically shows another example of a non-repaired state of geometry data of a defective section that is about to be repaired by the retouch section in the repair apparatus of the first embodiment of the present invention.

FIG. 9B graphically shows a repaired state of geometry data of the defective section shown in FIG. 9A that is repaired by the retouch section of the apparatus.

FIG. 10 is a diagram showing the shape of the defective section separated into micro regions corresponding to each modulator element of the spatial modulator device by the repair apparatus of the first embodiment of the present invention.

FIG. 11 graphically shows a defective section undesirably repaired by the repair apparatus according to the first embodiment of the present invention.

FIG. 12 graphically shows an example of the shape of a defective section that is to be repaired by the repair apparatus of the first embodiment of the present invention.

FIG. 13 is a schematic view of a repair apparatus and a repair system using the same according to a second embodiment of the present invention.

FIG. 14A is a perspective view graphically showing a part of the configuration of a spatial modulator device for use in a repair apparatus according to the second embodiment of the present invention.

FIG. 14B is a perspective view for explaining modulator elements of the spatial modulator device for use in the repair apparatus according to the second embodiment of the present invention.

FIG. 14C is a perspective view for explaining modulator elements of another spatial modulator device that can be used in the repair apparatus according to the second embodiment of the present invention.

FIG. 15 is a schematic view of a repair apparatus and a repair system using the same according to a third embodiment of the present invention.

FIG. 16 is a flowchart explaining a modified example of the repair process according to the first to third embodiments of the present invention.

### DETAILED DESCRIPTION OF THE INVENTION

Embodiments of the present invention will be explained as follows with reference to drawings. The same reference numerals are added to the same components in the drawings regardless of the embodiments, and duplicate explanations are omitted.

### First Embodiment

Explained first is a repair apparatus according to a first embodiment of the present invention.

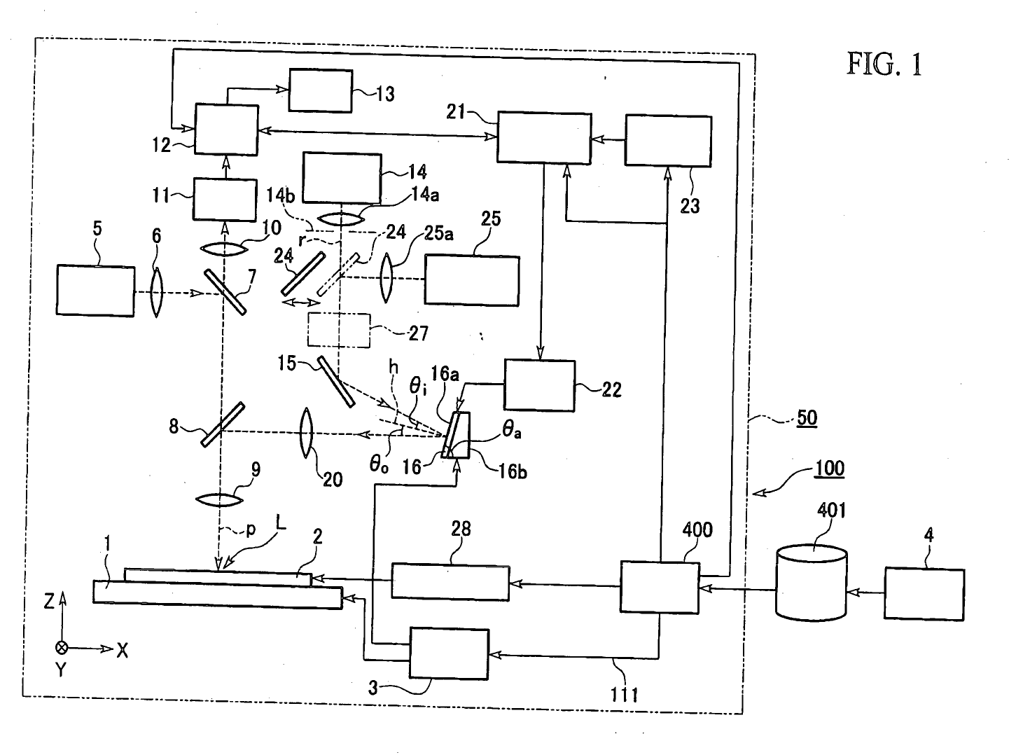

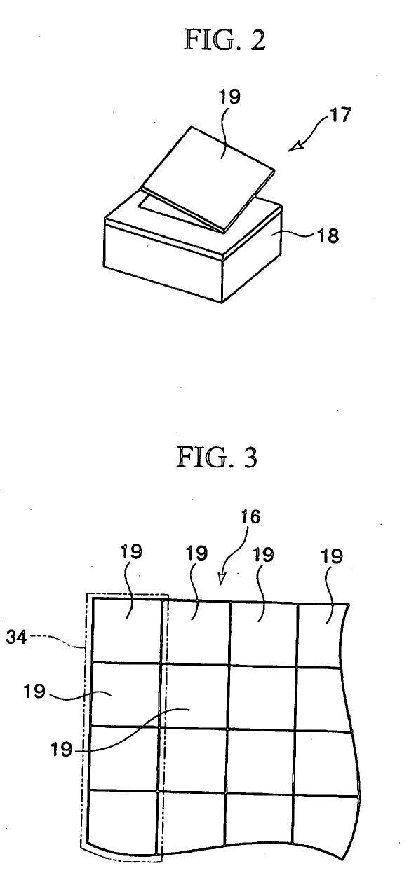

FIG. 1 is a schematic view of a repair apparatus according to a first embodiment of the present invention. FIG. 2 is a perspective view of a modulator element of a spatial modulator device for use in the repair apparatus according to the first embodiment of the present invention. FIG. 3 is a diagram showing the arrangement of modulator elements in a spatial modulator device for use in the repair apparatus according to the first embodiment of the present invention.

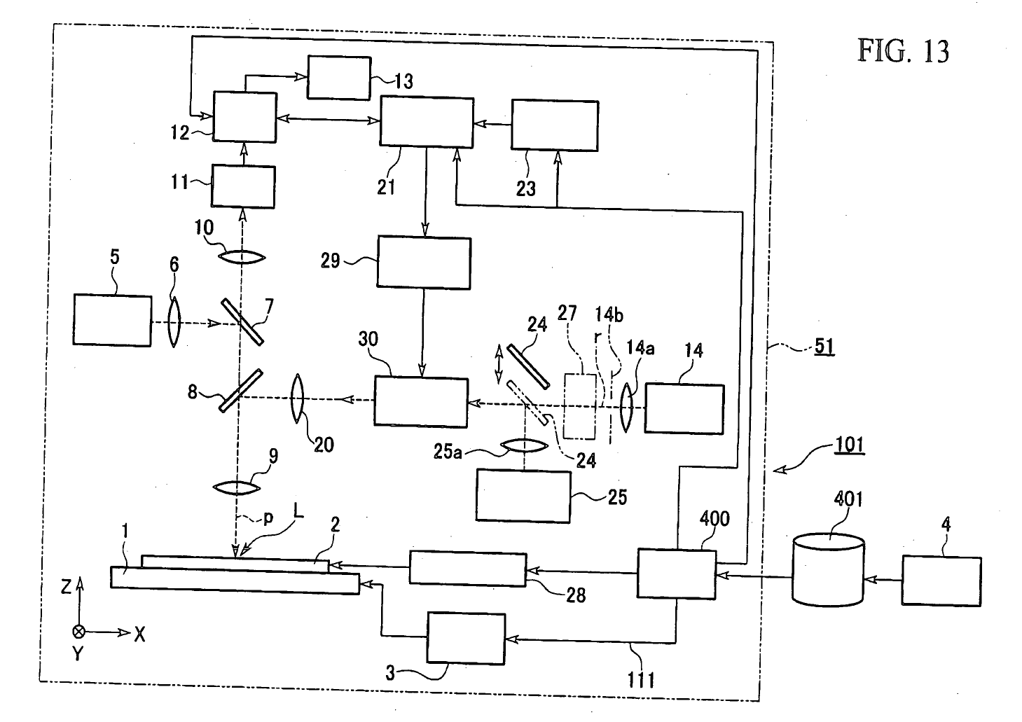

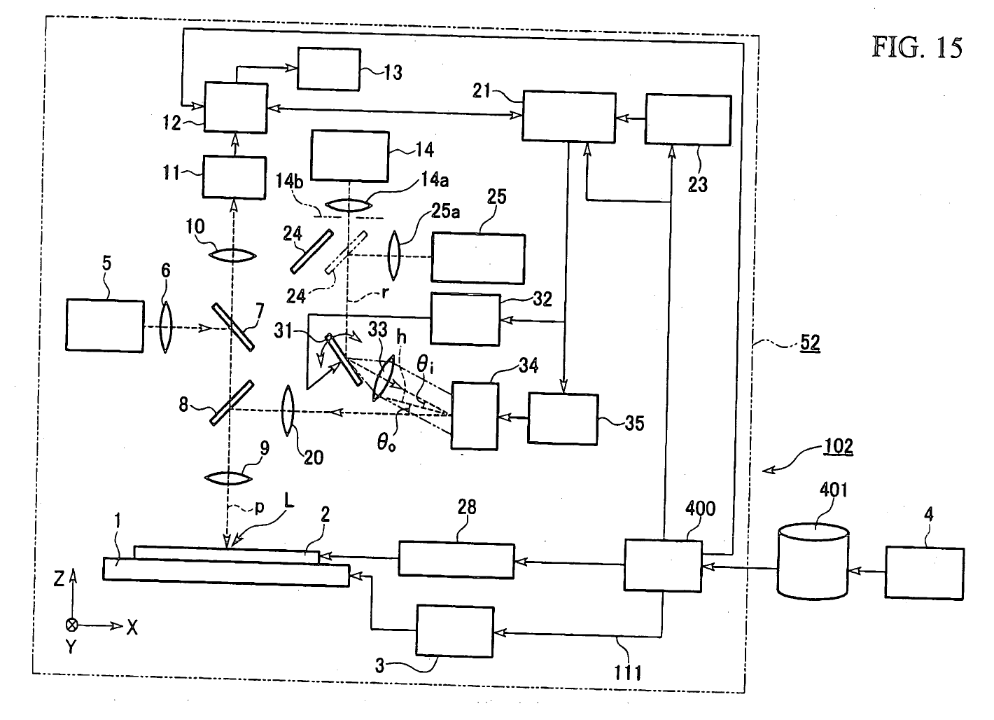

FIG. 1, as well as FIGS. 13 and 15, show an XYZ coordinate system for convenience in referring to directions in descriptions hereafter. In this right-handed rectangular coordinate system, an upward direction in the drawing indicates the normal Z direction; a right-hand direction in the drawing indicates the normal X direction; the ZX plane is in parallel with the drawing; and a direction going down on the drawing indicates the normal Y direction.

A repair apparatus 50 according to the present embodiment together with a substrate inspection apparatus 4 and a database server 401 constitute a repair system 100.

Substantially, the repair apparatus 50 includes: an X-Y stage 1; a control apparatus 400; a movement-drive control section 3; an illumination light source 5; a camera 11 (image-pickup apparatus); an image processing section 12 for repair object extraction (repair-object-extracting unit); a repair light source 14 (laser light source); a digital micromirror device unit (hereinafter called a DMD unit) 16 (spatial modulator device); a laser-shape-control section 21 (laser-shape-control unit); and a substrate carriage apparatus 28.

An LCD glass substrate 2 which is a substrate to be paired is mounted on the X-Y stage 1. The repair object is a substrate having micro patterns thereon to be repaired, e.g., semiconductor wafers, printed circuit boards, LCD color filters, and pattern masks. The movement-drive control section 3 controls driving of the X-Y stage 1 in the XY direction.

The control apparatus 400 is connected to an image processing section 12 for repair object extraction; a laser-shape-control section 21; a substrate carriage apparatus 28; a movement-drive control section 3; and a database server 401. A substrate inspection apparatus 4 is connected to the database server 401. The database server 401 stores inspection result data that includes coordinate, size, and defect type of defective sections produced on the glass substrate 2, resulting from defect inspections carried out to the glass substrate 2 by the substrate inspection apparatus 4. The control apparatus 400 receives inspection result data from the database server 401; controls the movement of the X-Y stage 1 driven in the XY direction as shown in the drawing in accordance with coordinate data of the defective section indicated by the inspection result data; and automatically positions the defective sections produced on the glass substrate 2 to a repair position L, i.e., an illumination position for laser light r emitted from a repair light source 14 which will be explained later.

In addition, the movement-drive control section 3 connected to a support base 16b so as to be capable of adjusting the cross-sectional shape of the laser light r if necessary, which will be explained later, carries out micro control with respect to position and orientation for the support base 16b.

Meanwhile, the control apparatus 400 may be configured to be computers having built-in software functioning as an image processing section 12 for repair object extraction, a laser-shape-control section 21, and a retouch section 23.

The illumination light source 5 emits light for illuminating the glass substrate 2. Provided on the optical path of the illumination light is a beam splitter 7 via a lens 6. An object lens 9 is disposed on the path of light reflected by the beam splitter 7. A beam splitter 8 is disposed between the beam splitter 7 and the object lens 9.

A camera 11 which may be a CCD, etc., is disposed on the line extending from the optical axis p passing through the object lens 9 and the beam splitters 7 and 8. The camera 11 picks up an image of the glass substrate 2 obtained through the lens 10 and the object lens 9, and outputs the image signal.

Although the object lens 9 is a piece of a component in the drawing, the object lens 9 includes object lenses provided to a revolver corresponding to a plurality of magnifications. The revolver is not shown in the drawing. The object lens 9 includes a reviewing (for inspection) object lens having relatively low magnification, e.g., 5× or 10×; and a repairing object lens having relatively high magnification, e.g., 20× or 50×. Glass material and coating for the repairing object lens are selected in view of efficient transmission of the laser light for use.

The image processing section 12 for repair object extraction, into which the image signal output from the camera 11 is input, obtains defect image data; compares the defect image data with reference image data; extracts a defective section on the glass substrate 2 based on the image data indicating the difference therebetween; binarizes; and produces defect shape image data. In addition, defect geometry data can be produced by obtaining the outline of the defective section by means of image processing based on the defect shape image data or the image data indicative of the difference so as to eliminate inside the outline. The image processing section 12 for repair object extraction displays the defect image data, the defect extraction image data, or the defect geometry data on the monitor 13.

The repair light source 14 emits laser light r for repairing the defective section of the glass substrate 2. The repair light source 14 uses a YAG laser oscillator that can emit a second-order harmonic, a third-order harmonic, and a fourth-order harmonic (wavelength λ₂=532 nm, λ₃=355 nm, λ₄=266 nm, respectively) at a reference wavelength λ₁ of 1.064 μm. Laser light r having a wavelength 3 of, e.g., 355 nm may be emitted in one shot. The light corresponding to the foregoing wavelengths may be selectively used in accordance with the material and processes for the glass substrate 2 to be repaired.

Provided on the optical path of the laser light r emitted by the repair light source 14 are a lens 14a and a mirror 15 in this order. The laser light r passing through these components is introduced to a DMD unit 16.

The laser light r emitted by the repair light source 14 is collimated by the lens 14a to substantially parallel light having an enlarged light bundle diameter. The laser light r deflected by the mirror 15 is incident into the DMD unit 16 at a certain fixed angle. Provided in the optical path between the lens 14a and the mirror 15 is a mirror 24 that is removable relative to the optical path. The mirror 24 reflects the light emitted by a repair-position confirmation light source 25, which is explained later, and introduces the reflected light onto the same optical path as that of the laser light r.

As indicated by chain double-dashed lines in FIG. 1, if necessary, a diaphragm 14b for rectifying the cross-sectional shape of the laser light r may be provided between the lens 14a and the mirror 24.

In addition, a collimating optical system 27 may be provided on the optical path between the lens 14a and the DMD unit 16 for equalizing the cross-sectional intensity distribution of the laser light r. As indicated by chain double-dashed lines in FIG. 1, the collimating optical system 27 can be disposed, for example, between the mirror 24 and the mirror 15 where the mirror 24 is disposed on the optical path.

Since various types of known collimating optical system 27 use, e.g., a fly-eye lens, an aspherical lens, and a kaleidoscopic rod, any configuration can be adapted based on necessity.

The DMD unit 16 has a plurality of digital micromirror devices (hereinafter abbreviated as DMDs) 17 as illustrated in FIG. 2 that are two-dimensionally arranged in vertical and horizontal directions as illustrated in FIG. 3.

A micromirror 19 capable of tilting at 0° and at +1100 is provided on a driving memory cell 18 of each DMD 17 as illustrated in FIG. 2. The tilting state of the micromirror 19 can be switched by digital control.

Static attraction produced based on a voltage difference acting on a gap between the micromirror 19 and the driving memory cell 18 causes the DMDs 17 to make high-speed switching movement at angles of 0° and ±10°. Such DMDs 17 are known and disclosed by Japanese Unexamined Patent Application, First Publication No. 2000-28937. The rotation of the micromirror 19 is limited by, for example, a stopper within ±100 where the turned-on state of the micromirror 19 tilts at ±10° and the turned-off state of the driving memory cell 18 recover to a horizontal angle, i.e., 0°. Meanwhile, the micromirror 19 formed by using semiconductor-manufacturing technology, e.g., an MEMS (Micro Electro Mechanical Systems) is a rectangle each side of which outline is in an order of several microns to several tens of microns. The present embodiment adapts a micromirror of, for example, about 16 μm per side. The DMD unit 16 is constituted by micromirrors 19 two-dimensionally arranged on the driving memory cells 18 as illustrated in FIG. 3.

The reference reflection surface 16a of the DMD unit 16 indicates the tilting angle of 0° the micromirror 19 of each DMD 17. The reference reflection surface 16a tilts at an tilt angle of θₙ relative to the XY plane as shown in the drawing so that, when each turned-on state of micromirror 19 tilts at +10°, an angle θi is >0 where θi is a counter-clockwise angle defined on the ZX plane between an incident optical axis of the laser light r and a line h in the drawing; and an angle θₒ is >0 where θₒ is a reverse angle to the direction of h defined between the optical axis of the laser light r emitting from the reference reflection surface 16a and the line h.

The tilt angle θₙ is set based on correlations among the mirror 15, the lens 20, and the beam splitter 8 so that the turned-on state of the laser light r incident into the reference reflection sure 16a conforms to the optical axis passing through the lens 20 and the beam splitter 8.

The DMD unit 16 is attached to the support base 16b and is capable of adjusting the tilt angle θₙ of the reference reflection surface 16a in the XY direction and in the direction of θ of the tilt angle θₐ the ZX plane. Although an independent drive-control section may be provided, the support base 16b is connected to a movement-drive control section 3 that provides micro control to the support base 6b in the XY plane in the present embodiment. Micro control as such allows the cross-sectional shape of the laser light r to conform to the defective section of the glass substrate 2.

The angle θₒ of in the emitting direction of the laser light r is determined based on the rotational angle of each micromirror 19 corresponding to turned-on state of driving memory cell 18. The laser light r emitted at the emission angle θₒ enters the lens 20 followed by the beam splitter 8. The emitted light bundle is at infinity until reaching the object lens 9 since the disposition of the reference reflection surface 16a corresponds to the position of the focal point of the lens 20.

In addition, tuning off the driving memory cell 18 causes the laser light r to be reflected in the direction h. The laser light r does not pass through the lens 20 or enter the beam splitter 8.

Meanwhile since the laser light r emitted by the repair light source 14 and reflected by the mirror 15 enters the DMD unit 16 at an incident angle θi, the mirror 15 may be eliminated, i.e., the laser light r emitted by the repair light source 14 may enter the DMD unit 16 directly.

A repair-position confirmation light source 25 illuminates the DMD unit 16 with light having a light bundle diameter substantially the same as that of the laser light r. The light is substantially collimated by the lens 25a and reduced in diameter by a diaphragm which is not shown in the drawing if necessary to a diameter substantially the same as that of the laser light r. The light is incident to the mirror 24 inserted in the optical path between the repair light source 14 and the mirror 15 and is introduced to the same optical path as that of the laser light r. Although the lenses 14a and 25a are described schematically in FIG. 1 as single lenses each constituting a beam expander optical system. In this configuration, light from the repair light source 14 and the repair-position confirmation light source 25 may be incident to optical fibers; and light-emitting ends of the optical fibers may be disposed at predetermined positions on optical paths. In this case, lenses 14a and 25a are collimating lenses.

Emitting light from the repair-position confirmation light source 25 and introducing the emitted light to the DMD unit 16 reflects the introduced light at each turned-on state of the micromirror 19; thereby projecting an image pattern equal to a defect shape pattern onto the glass substrate 2.

In such a configuration of the optical system, the camera 11 is disposed above the glass substrate 2 so as to dispose the beam splitter 8 therebetween; and the DMD unit 16 is disposed at a position somewhat shifted relative to the glass substrate 2. The arrangement of the camera 11 and the DMD unit 16 is conjugate relative to the glass substrate 2.

The laser-shape-control section 21 reads the defect geometry data, produced by the image processing section 12 for repair object exaction, of each defective section on the glass substrate 2. The laser-shape-control section 21 sends a control signal to the DMD driver 22. The control signal turns on a driving memory cell 18 of each micromirror 19 of the DMD unit 16 corresponding to the defect geometry data and turns off a driving memory cell 18 of each micromirror 19 disposed apart from other region.

In addition, the image processing section 12 for repair object extraction having illuminated laser light r and the repaired defective section of the glass substrate 2 obtains the image data at the same position by means of the camera 11, compares the image data with a reference image data, and determines as to whether the defective section has been fully repaired. If the determination results is an imperfect repair, another defect geometry data for the defective section is produced based on the post-repair difference image data. The laser-shape-control section 21 reads the geometry data of the defective section by means of the image processing section 12 for repair object extraction; and turns on the driving memory cell 18 of each micromirror 19 of the DMD unit 16 corresponding to the geometry data.

Also, the laser-shape-control section 21 has a retouch section 23 which provides manual correction for defective sections if not all the regions corresponding to the defective section cannot be extracted from a defect shape image data produced by the image processing section 12 for repair object exaction, or if a correct region is erroneously extracted as a defective section.

The retouch section 23 regionally sets a non extracted defective region and registers the region as a defective section by means of manual operation using; a graphic tool. Otherwise, the retouch section 23 regionally sets an erroneously extracted region as a defective section and registers the region as a correct region.

The DMD driver 22 drives turned-on or turned-off state of each driving memory cell 18 of the DMD unit 16 in accordance with a control signal sent from the laser-shape-control section 21.

Explained next will be a substrate inspection apparatus 4 used in a repair system 100.

The substrate inspection apparatus 4 is an inspection apparatus that is capable of inspecting a defect by obtaining an image of the glass substrate 2; and obtaining at least a coordinate data of the defect on the glass substrate 2. That is, it constitutes a defect-position-detecting unit. An example of the substrate inspection apparatus 4 may be a so-called automatic pattern inspection apparatus that obtains a scanned image of a glass substrate 2 and automatically detects a defect Patent Publication No. 2002-277412 provides detailed explanations regarding the substrate inspection apparatus.

Explained next will be repair steps.

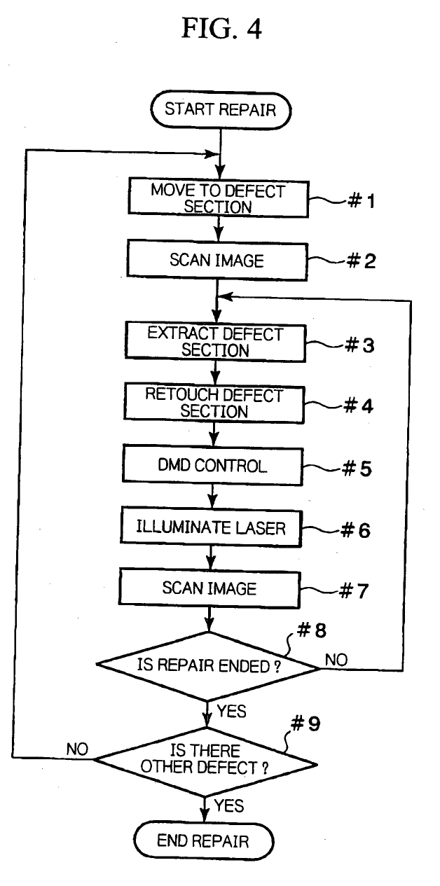

FIG. 4 shows repair steps. In Step #1, a glass substrate 2 carried by a substrate carriage apparatus 28 is set on the X-Y stage 1 and positioned on the X-Y stage 1 so that the set position coincides with a coordinate data based on an inspection result data 1111 sent by the substrate inspection apparatus 4. For example, a reference position is compensated by calculating more than a position of a reference position mark disposed on the glass substrate 2 with respect to the coordinate system of the X-Y stage 1 to detect a shift amount between a perspective center and the reference position mar. Temporarily a positional information of the reference position mark exists on a control apparatus 400 of a repair apparatus 50 or on a database server 401.

Passing the inspection result data 1111 to the movement-drive control section 3 provides movement control to the X-Y stage 1 having the reference position compensated in the XY direction plane; thereby positioning the defective section on an optical axis p. Even if the defect from the inspection result data 1111 is greater than a predetermined defect size and is not repaired normally, is moved for confirmation so that the optical axis p comes above the defective section.

In Step #2, the camera 11 pick up an image of the defective section on the glass substrate 2 obtained through the lens 10, the beam splitters 7 and 8, and the object lens 9; and the camera 11 puts out the image signal. Magnification of the object lens 9 used here is low, e.g., 5× or 10×.

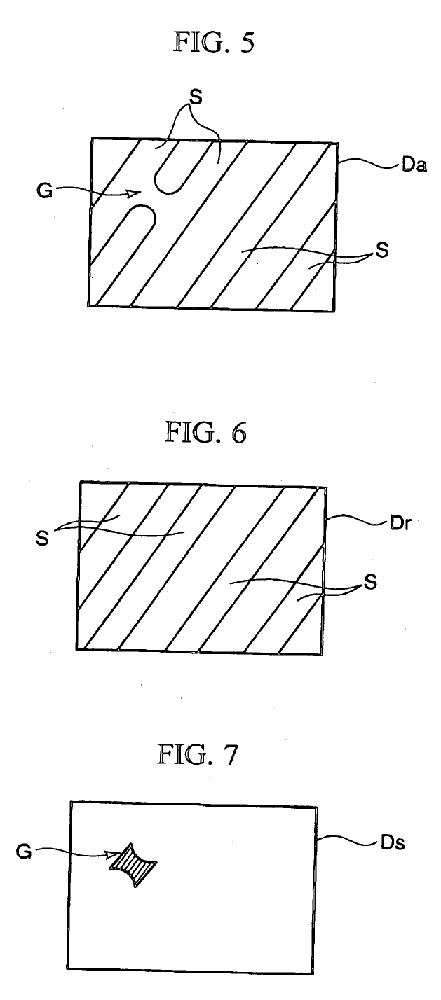

An image signal output from the camera 11 is put into the image processing section 12 for repair object extraction which obtains a defect image data Da in which a defective section G connecting patterns S exists as illustrated in, for example, FIG. 5.

In next Step #3, the image processing section 12 for repair object extraction compares the defect image data Da with a reference image data Dr not having a defective section as illustrated in FIG. 6, and extracts the defective section G on the glass substrate 2 based on its difference image data. Consequently the image processing section 12 for repair object extraction binarizes the image data extracted from the defective section G and produces a defect geometry image data Ds having a black label indicatively converted from the region corresponding to the defective section G and a white label indicatively converted from correct region as illustrated in FIG. 7. The image processing section 12 for repair object extraction displays the defect image data (or the difference image data) and the defect geometry image data Ds on the monitor 13.

Confirmed here is as to whether the defect of a normally non-repaired size substantially coincides with that of the inspection result data 1111. If the size is met, steps #4 to #7 are omitted and the repair step proceeds to a next defective section. If the size is not met and the defect is smaller than the predetermined size, i.e., the defect is repairable, the repair step proceeds to next.

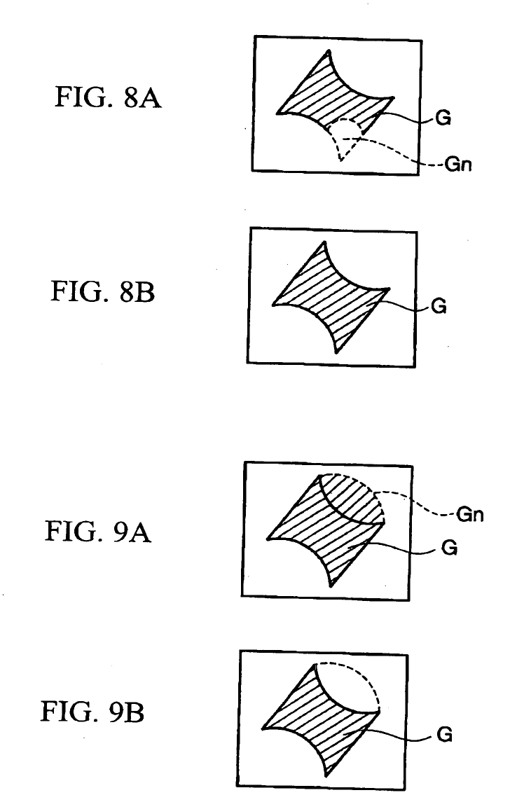

The defect geometry image data Ds displayed on the monitor 13 is observed and compared with the defect image data (or the difference image data). The observation will result in a case of finding a non-extracted defective region Gn as illustrated in FIG. 8A, or in a case of finding a correct region erroneously extracted as a defective region Gh.

Uneven contrast in the defective section G in the defect geometry image data Ds causes this inability to accurately extract the defective section G along the outline, i.e., a high contrast region can be extracted, but a low contrast region cannot be extracted.

Regionally setting the non-extracted defective region Gn as illustrated in FIG. 8A as a defective section by a manual operation using a graphic tool of the retouch section 23 while observing the defective section G displayed on the monitor 13 causes the retouch section 23 to register the defective region Gn displayed in FIG. 8B as a defective section in Step #4. Accordingly an entire defective section G including the defective region Gn constitutes the defective section.

Also, with respect to the defective region Gn illustrated in FIG. 9A, registering the erroneously extracted defective region Gn as a correct region by a manual operation using a graphic tool of the retouch section 23 causes the retouch section 23 to delete the registered defective region Gn from the defective section as illustrated in FIG. 9B in Step #4.

In next Step #5, the laser-shape-control section 21 receives the defect geometry image data Ds from the image processing section 12 for repair object exaction and reads a geometry data of the defective section G of the glass substrate 2 based on this defect geometry image data Ds. The laser-shape-control section 21 further sends a control signal to a DMD driver 22. The control signal turns on each driving memory cell 18 of each micromirror 19 of the DMD unit 16 corresponding to the region of the binarized and black-labeled defective section G.

The DMD driver 22 drives turned-on or turned-off state of each driving memory cell 18 of the DMD unit 16 in accordance with a control signal sent from the laser-shape-control section 21.

For example, as illustrated in FIG. 10, the laser-shape-control section 21 separates the shape of the defective section G into a plurality of each micro region M corresponding to each micromirror 19. The laser-shape-control section 21 consequently sends out a control signal to the DMD driver 22. The control signal turns on each driving memory cell 18 of each micromirror 19 corresponding to each micro region M of the defective section G.

This allows rotation of each micromirror 19 corresponding to each micro region M of the defective section G to be controlled by +10° by means of the signal, indicative of a turned-on state, output by the DMD driver 22.

In next Step #6, a mirror 24 is inserted into the optical path of the laser while rotatively controlling each micromirror 19 of the DMD unit 16 and while the repair-position confirmation light source 25 is turned on. Emitting light for illumination having a light bundle diameter substantially the same as that of the laser light r from the repair-position confirmation light source 25 to the DMD unit 16 via the mirrors 24 and 15 projects an image of the illumination light having the defect shape pattern of the DMD unit 16 onto the glass substrate 2 via each tuned-on state of the micromirror 19. Whether the pattern image indicative of the defect shape projected on the glass substrate 2 conforms to the defective section G can be confirmed with the monitor 13. If the defective section G is shifted from the pattern image indicative of the defect shape, the defective section G is conformed to the pattern image indicative of the defect shape by moving the X-Y stage 1.

The pattern image indicative of the defect shape may be conformed to the defective section G by moving the pattern image indicative of the defect shape and operating the support base 16b if the shift amount of the defective section G is not significant.

Consequently the mirror 24 is retracted from the optical path of the laser, and the laser light r is emitted in a shot from the repair light source 14. The laser light r in a shot reflected by the mirror 15 is incident into the DMD unit 16 at an incident angle of θi, and reflected by each micromirror 19 rotated by +10° corresponding to the region of the defective section G. The cross-sectional shape of the laser light r reflected by the micromirrors 19 conforms to the shape of the defective section G.

Consequently, the laser light r reflected by the micromirrors 19 and passing through the lens 20 and the beam splitter 8 is condensed by the object lens 9, and is illuminated onto the defective section G of the glass substrate 2. Since the laser light r focused by the object lens 9 into a cross-sectional shape conforming to the shape of the defective section G is illuminated to the defective section G, one shot of this laser light r removes the defective section G on the glass substrate 2.

Illuminating the laser light r into the inside of the outline of a small defective section G sometimes causes ineffective defect removal, because the shape of each micromirror 19 of the DMD unit 16 is not placed along a contour line, i.e., expanding to outside or inside. Exchanging the object lens 9 to a greater magnification may improve such a case. It should be noted that the shape of may not have to conform to the contour line. That is, it can be taken that the illumination is carried out substantially along the contour lime as long as a purpose for the repair can be achieved such as cutting a short-circuited wirings.

Consequently the camera 11 picks up an image of the repaired defective section G and outputs the image signal thereof. The image processing section 12 for repair object extraction compares the repaired defect image data Da picked up by the camera 11 with the reference image data Dr as illustrated in FIG. 6, and determines as to whether the defective section G is fully repaired. Meanwhile the image processing section 12 for repair object extraction may display the repaired defect image data Da on the monitor 13 and may determine as to whether the defective section G is fully repaired by observing the image of the displayed defective section G.

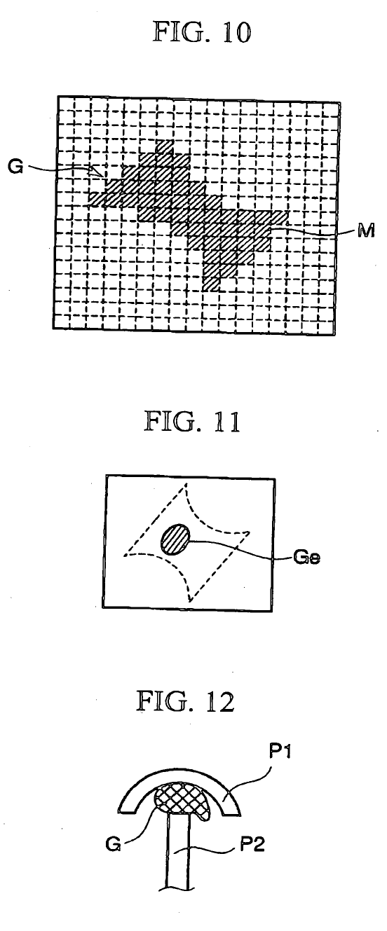

On the other hand, illuminating the laser light r onto the defective section G may not sometimes be able to remove all the defective section G. In this case, an unremoved part of the defective section G remains as illustrated in FIG. 11. The repair step goes back to Step #3 upon determining that the defective section G is not fully repaired. The image processing section for repair object extraction compares the defect image data Da picked up in Step #7 to the reference image data Dr, and extracts the incompletely repaired defective section Ge remaining on the glass substrate 2 as illustrated in FIG. 11 based on the difference image data.

Steps #4 to #8 are repeated similarly to the above explanation.

If the determination in Step #8 results in indicating that the defective section G is fully repaired, the movement drive control section 3 retrieves a next defective section based on the inspection result data for the glass substrate 2 received from the substrate inspection apparatus 4 in Step #9. The repair steps goes back to Step #1 again if a defective section is found. The repair steps come to an end if a defective section is not found.

The repair apparatus 50 in accordance with the present embodiment extracts the geometry data of the defective section G based on the defect image data obtained by picking up an image of the defective section G on the glass substrate 2. High speed control is carried out with respect to the angle of each micromirror 19 of the DMD unit 16; thus, a defect shape pattern having the same shape as that of the defective section G is formed. The laser light r is reflected by each micromirror 19 forming the defect shape pattern. The cross-sectional shape of the laser light r is rectified to the shape same as that of the defective section G; thus, the rectified shape is illuminated on to the defective section G of the glass substrate 2.

Accordingly, since the size of each micromirror 19a or 19b is, for example, a 16 μm-by-16 μm of micromirror, if any shape of the defective section G of the resist pattern or the etching pattern is in a minute and complex shape formed by combining linear lines and curved lines, the laser light r having a cross-sectional shape substantially conforming to the shape of these defective sections G can be formed quickly and easily.

For example, if the defective section G exists in a section where a curved pattern P1 faces a linear pattern P2 as illustrated in FIG. 12, and if the defective section G is a contorted oval in shape, the use of the DMD unit 16 can form a defect shape pattern having a shape the same as that of the defective section G quickly. Accordingly, illuminating the laser light r having a rectified shape corresponding to the defective section G onto the defective section G can repair only the defective section G without illuminating the laser light r onto the outside of the defective section G. Therefore, repairing the defective section G of the etching pattern produced in LCD-manufacturing process illuminates the laser light r onto only the defective section G in a metal pattern on the glass substrate, thereby providing no damage onto the glass substrate.

In addition, the use of the DMD unit 16 can provide rapid control to the micromirror 19, thereby instantaneously forming a defect shape pattern corresponding to variously different defective sections G to be repaired; facilitating the rectifying of the cross-sectional shape of the laser light r in accordance with the shape of the defective section G; and shortening a repair time for the defective section G significantly. Also, the capability that conforms the cross-sectional shape of the laser light r to each shape of the defective section G accurately results in improving product yield in LCD manufacturing.

Rectifying the cross-sectional shape of the laser light r corresponding to the shape of an incompletely-repaired defective section G and providing a secondary illumination can fully repair the defective section G, thereby improving the product yield even if one illuminating shot of laser light r cannot fully repair the defective section Q.

Also, manual operation using a graphic tool of the retouch section 23 can correct the defective regions Gn and Gh where the defective region Gn is caused by uneven contrast in the defect geometry image data Ds, and the defective region Gh indicates an erroneously extracted correct region. In addition, the manual operation can repair the automatically-and-erroneously-extracted geometry data of the defective section G to a correct geometry data of the defective section G.

It should be noted that the previously explained first embodiment of the present invention is not limited to the above embodiment as such. That is, components used therefor can be modified without departing from the spirit thereof when actually carried out. Next, a modified example of the present embodiment will be described as follows.

For example, laser light is rectified to a defect shape pattern by driving the micromirror 19 of the DMD 17 to a turned-on state in the above embodiment. In contrast, in a modified case, laser light may be rectified to the defect shape pattern by turning off the micromirrors 19 corresponding to the defect shape pattern and turning on the micromirrors 19 except the defect shape pattern.

Also, for example, the geometry data of a defective section G is obtained based on the defect geometry image data Ds which is a difference image obtained by comparing a defect image data Da with the reference image data Dr by means of the image processing section 12 for repair object extraction in the above embodiment. In another modified case, an operator may observe the image of the output defective section G displayed on the monitor 13 and use a tablet, etc., to obtain the geometry data of the defective section G.

### Second Embodiment

Explained is a repair apparatus according to a second embodiment of the present invention.

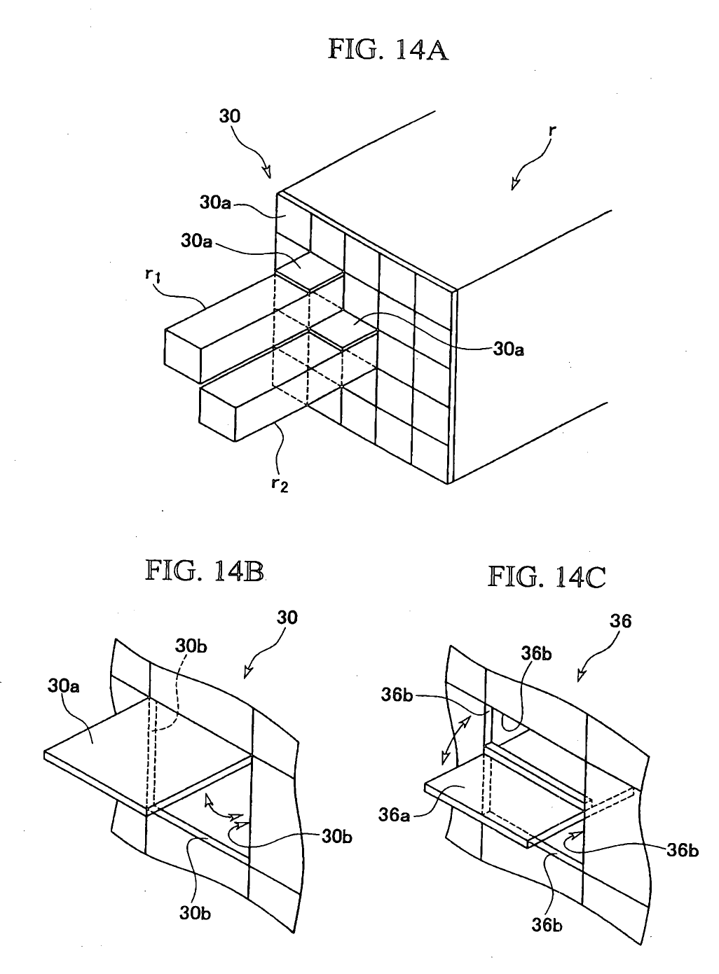

FIG. 13 is a schematic view of a repair apparatus according to the second embodiment of the present invention. FIG. 14A is a perspective view graphically showing a part of the configuration of a spatial modulator device for use in a repair apparatus according to the second embodiment of the present invention. FIG. 14B is a perspective view for explaining modulator elements of the spatial modulator device for use in the repair apparatus according to the second embodiment of the present invention. FIG. 14C is a perspective view for explaining modulator elements of another spatial modulator device that can be used in the repair apparatus according to the second embodiment of the present invention.

A repair apparatus 51 according to the present embodiment together with a substrate inspection apparatus 4 and a database server 401 constitute a repair system 101.

The repair apparatus 51 includes a transmissive spatial modulator 30 (spatial modulator device) and a spatial modulator driver 29 in place of the DMD unit 16 and the DMD driver 22 of the repair apparatus 50 according to the first embodiment of the present invention. Features different from the first embodiment are explained as follows.

As illustrated in FIG. 14A, the transmissive spatial modulator 30 is a transmissive spatial modulator device which carries out spatial modulation. The transmissive spatial modulator 30 is disposed on the optical path of the laser light r to transit a part of the laser light r in accordance with the position in the cross-section of the optical path. In an adaptable configuration, for example, a plurality of flips 30a (modulator element of spatial modulator device) supported by a rotative hinge at a side of a light-reflective micro rectangular plate can be arranged two-dimensionally by using MEMS technology capable of manufacturing a micro-and high-speed-movable structure. Each flip 30a to which static voltage is applied in accordance with a control signal can rotate around the rotative hinge. The rotation angle is 0° when the static voltage is not applied, i.e., in the turned-off state; thus, each flip 30a is arranged on a plane. On the other hand, the rotation angle is 90° when the static voltage is applied, i.e., in the turned-on state; thus, each flip 30a is rotated to a position orthogonal to the turned-off state of the plane.

The laser light r is configured to be incident substantially along the normal of the plane on which the turned-off state of flips 30a are arranged.

The spatial modulator driver 29 is a control mechanism which drives each flip 30a of the transmissive spatial modulator 30 based on a control signal which selects one of the turned-off state and the turned-on state transmitted from the laser-shape-control section 21.

This configuration controls each flip 30a to the turned-off state or to the turned-on state based on the control signal of transmitted from the laser-shape-control section 21. Turning on a certain flip 30a forms an opening corresponding to the disposition of the turned-on state of the flip 30a by means of the edge section 30b of the flip 30a adjacent to the turned-off state of flip 30a; thus, laser light r is transmitted to the position of the turned-on state of flip 30a (see laser light r₁, r₂ in FIG. 14a).

Therefore, unless the opening section of the turned-on state of flip 30a is in the way of the optical path of the emitted laser light r, the amount of transmitted laser light r remains the same if the incident angle of the laser light r changes.

This configuration of the repair apparatus 51 and the repair system 101 allow the flip 30a of the transmissive spatial modulator 30 to have spatial modulation function corresponding to the micromirror 19 of the DMD unit 16. The transmissive spatial modulator 30 is advantageous because the transmissive spatial modulator 30 eliminates loss in light amount since the turned-on state of light is transmitted from the opening section.

Also, since an angular shift of the arrangement of the transmissive spatial modulator 30 does not affect the traveling direction of the transmitted light, and since a change in light amount based on miss-alignment associated with diffraction phenomena is less significant than in a case of the reflective spatial modulator device, it is advantageous that alignment of each optical element is easy and the apparatus can be assembled easily.

Meanwhile, the transmissive spatial modulator device may be a transmissive spatial modulator 36 as illustrated in FIG. 14C in place of the transmissive spatial modulator 30 of the present embodiment.

A rotative hinge is disposed in the center of the transmissive spatial modulator 36 in place of the flip 30a of the transmissive spatial modulator 30. The rotation angle of 0° indicative of the turned-off state and the rotation angle of 90° indicative of the turned-on state can be switched.

The turned-on state of flip 36a rotates by 90° so that the flipping surface is directed in a direction substantially along the optical path, hereby forming an opening section surround by a plurality of edge sections 36b and flips 36a of the adjacent flip 36a; thus, the laser light r is transmitted.

The transmissive spatial modulators 30 and 36 caring out spatial modulation operation by means of the rotative hinges utilizing the MEMS technology are advantageous because of a greater extinction ratio relative to a transmissive spatial modulator device of another type; therefore, the use of light can be efficient and high-speed spatial modulation can be obtained.

The transmissive spatial modulator device of another type can be adapted unless there is a problem regarding light amount and modulation speed. Preferable examples are, liquid crystal shutters (FLC), Grating light bulbs (GLV), and PZT devices that modulate transmitted light by means of electrooptic effect.

Since the light amount of these transmissive spatial modulator devices will not be affected by miss-alignment of diffraction-phenomena-related diffractive optical devices, it is advantageous in facilitating the alignment (alignment) of the optical devices; thus, the assembly of the apparatus can be facilitated.

### Third Embodiment

Explained next is a repair apparatus according to a third embodiment of the present invention.

FIG. 15 is a schematic view of a repair apparatus according to the third embodiment of the present invention.

A repair apparatus 52 according to the present embodiment together with a substrate inspection apparatus 4 and a database server 401 constitute a repair system 102.

The repair apparatus 52 is provided with a movable mirror 31, a one-dimensional DMD 34 (spatial modulator device), and a DMD driver 35 in place of the mirror 15, DMD unit 16, and DMD driver 22 provided to the repair apparatus 50 according to the first embodiment of the present invention. In addition, the repair apparatus 52 is provided with a mirror-controlling section 32 and a lens 33. Features different from the first embodiment are explained as follows.

The movable mirror 31 is a deflection optical element for deflecting laser light r substantially collimated by the lens 14a. The movable mirror 31 is configured to be rotative around at least an axis, e.g., a Y axis that is orthogonal to the plane of the drawing page based on a control signal of emitted by the mirror-controlling section 32. An adaptive example is a deflection optical element such as a galvano mirror.

The lens 33 is an optical device that emits the laser light r reflected by the movable mirror 31 in substantially a fixed direction with a certain range of perspective angle. An adaptive example is an optical device that has a positive power in the plane orthogonal to the rotation axis of the movable mirror 31 and has a focal position disposed to substantially coincide with the deflecting point of the movable mirror 31.

The one-dimensional DMD 34 is a reflective spatial modulator device (see FIG. 3) in which the DMDs 17 according to the first embodiment are arranged one-dimensionally. The DMDs 17 are disposed along a scanning line of the laser light r deflected by the movable mirror 31. The correlation between the laser light r and the DMDs 17 is the same as that of the first embodiment except the DMDs 17 are one-dimension disposed one-dimensionally in the present embodiment. The laser light r is reflected by the turned-off state of the micromirror 19 of the DMD 17 in a direction h having an incident angle θi relative to the incident direction; and the laser light r is reflected by the turned-on state of the micromirror 19 in a direction having an angle θₒ in the counterclockwise direction relative to the direction h. The laser light r travels along the optical axis of the lens 20 and is illuminated onto a repair position L via the beam splitter 8 and the object lens 9.

Accordingly, the repair apparatus 52 emits a beam light bundle of the laser light r having a diameter an area cross-section of the light bundle substantially the same as an area of the micromirror 19 or greater by means of the repair light source 14 and the lens 14a; thus the movable mirror 31 is illuminated. Consequently rotating tilting the movable mirror 31 around at the Y-axis as illustrated scans the laser light r on each micromirror 19 of the one dimensional DMD 34.

Each micromirror 19 controlled to be turned on by the DMD driver 35 reflects the laser light r and introduces the reflected laser light r onto the repair position L via the lens 20, the beam splitter 8, and the object lens 9. Therefore, every rotation of the movable mirror 31 scans the laser light r on a line area on the glass substrate 2.

In Step #5 as shown in FIG. 4, the laser-shape-control section 21 according to the present embodiment time-shares the control signal transmitted to the DMD driver 22 based on a two-dimensional defect shape image data, and transmits the time-shared signal to the DMD driver 35. Also, the laser-shape-control section 21 transmits a line-synchronizing signal of corresponding to the time-shared control signal to the mirror-controlling section 32.

In Step #6 of FIG. 4, the mirror-controlling section 32 carries out rotation control so that the controls the tilting movement of the movable mirror 31 that scans the one-dimensional DMD 34 per each line-synchronizing signal. Therefore, the laser light r reflected by the one-dimensional DMD 34 is scanned in the X-axis direction, on the glass substrate 2 as shown in the drawing.

On the other hand, the movement-drive control section 3 drives the X-Y stage 1 so that the position of the repair position L of the glass substrate 2 moves in the Y-axis direction as shown in the drawing in a line-synchronizing signal period.

Accordingly, the laser light r scanning on the glass substrate 2 repairs the defective section.

The one-dimensional DMD 34 used for the spatial modulator device; in the repair apparatus 52 according to the present embodiment is advantageous because the apparatus is cheaper than the two-dimensional DMD unit 16.

The range of i the laser light r that may be limited to a range of illuminating the micromirror 19 of the one-dimensional DMD 34 is advantageous because the light bundle diameter of the laser light can be reduced; thus the output from the laser light source can be restricted relative to a case using the DMD unit 16.

In addition, the present embodiment is advantageous since uneven brightness depending on the illuminating position of the laser light is reduced; thus, desirable repairing can be obtained without disposing a collimating optical system 27, i.e., with a simpler structure.

The lens 33 according to the present embodiment may be an anamorphic lens having an appropriate power in the rotative axis direction. Since this case of laser light r transmitting through the lens 33 is condensed in the rotative axis direction, i.e., a direction orthogonal to a direction in which the DMDs 17 of the one-dimensional DMD 34 are arranged, the laser light r having a greater light bundle diameter can be condensed on the micromirror 19. Accordingly, this is advantageous because the laser light r can be used more efficiently.

A smaller rotative angle of the movable mirror 31 having a smaller change in a perspective angle may allow the lens 33 to be omitted.

As previously explained as to repairing a defective section on an LCD glass substrate 2 in the previous embodiments, an object of the repair may be all kinds of defective sections to be repaired including correcting a defective section on a semiconductor wafer, correcting a defective section on a reticle; or correcting a defect shape of precision instruments. In particular, the optimum method for repairing a microshape or complex shape.

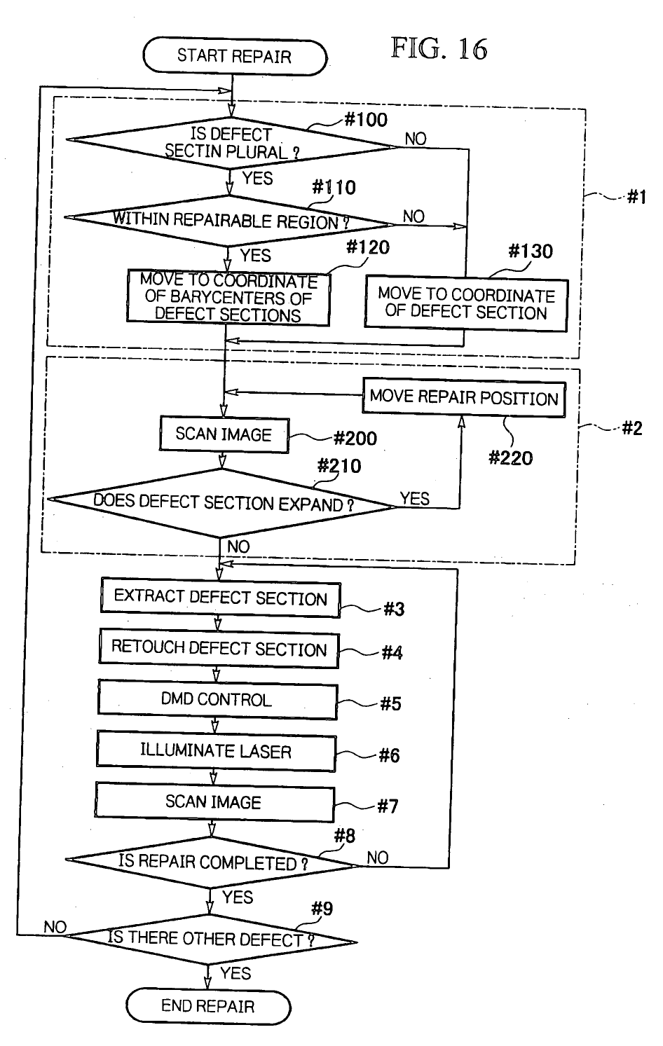

Also, the repair process explained above with reference to a flowchart shown in FIG. 4 may be modified to a flowchart as shown in FIG. 16.

FIG. 16 shows the flowchart explaining a modified example of the repair process according to the first to third embodiments of the present invention.

In the present modified example shown in FIG. 16, inspection result data 1111 is read in Step #1 of Step #100 prior to reading an image, and as to whether a plurality of defective section exists is determined. If a plurality of defective sections do not exist, the repair process moves to Step #130 and moves to the coordinate of the defective section. If a plurality of defective sections exist, moves to next Step #110.

The Step #110 determines as to whether all the defective sections are included in a reparable region fixed corresponding to the size of the DMD unit 16 and as to whether all the defective sections can be repaired in one shot. If all the defective sections are included, moves to next Step #120. If not included, Step #130 is executed.

For example, a barycenter of central coordinates of the plurality of defective sections are obtained based on the inspection result data 1111 in Step #120. The barycenters are conformed to the center of the perspective so that a plurality of the adjacent defective sections can be repaired at once. The repair position is moved by controlling the X-Y stage 1 so that all the defective sections are included in the repairable region.

Also, low accuracy of the inspection result data output from the substrate inspection apparatus 4, e.g., an automatic pattern inspection apparatus may cause an actually extracted defect to be more significant when scanned at the repair position. New and non-detected defective sections may sometimes be extracted. This sometimes results in expanding the defective section over the repairable region fixed corresponding to the size of the DMD unit 16. The use of the low power object lens 9 for picking up an image of the defective section enables determination as to whether the defective section expands over the repairable region.

In the present modified example shown in FIG. 16, an image of the defective section is scanned in Step #200 of Step #2, and as to whether the defective section expands over the repairable region is determined in Step #210.

If the defective section is determined to expand over the repairable region, the repair position is moved by controlling the X-Y stage 1 so that all the defective sections are included in the repairable region. Consequently, Step #200 is executed again.

The repair process moves to Step #3 in non-expanding case.

This permits efficient positioning because the geometry data (defect geometry image data Ds) of the repair object is extracted from the picked-up image data and is repaired with one shot of laser light illumination.

While the steps #1 and #2 are modified in the present modified example as previously explained, at least one of Step #1 and #2 may be modified as previously explained if necessary.

Examples of the inspection result data 1111 explained in the previous embodiments are, e.g., coordinate data indicative of the position of the defective section and information indicative of shape and size to be transmitted. If the resolution of the substrate inspection apparatus permits to be used for a defect geometry image data Ds of the image processing section 12 for repair object extraction, the image data itself of the defective section may be transmitted to the repair apparatus. Since the process of picking up an image by means of the camera 11 can be omitted in this case, it is advantageous because quick repair can be obtained.

While the explanation was previously explained with reference to the above embodiments, the image-pickup apparatus and the spatial modulator device are disposed at a conjugate correlation relative to the repair object, the correlation of the spatial modulator device and the repair object may be shifted from the conjugate position to defocus the laser light illuminated onto the repair object if, for example, the image of each the modulator element of the spatial modulator device affects the repair object. This can reduce uneven brightness on the repair object caused by a temporarily focused modulator element of the spatial modulator device; thus, accuracy in repair can be improved.

Also, the uneven brightness on the repair object may be reduced by means of decreasing an NA by disposing a diaphragm in the optical path, limiting a lens diameter, or varying a pupil diameter.

To explain more specifically, Abbe theory indicates that an optical system needs to have an NA (numerical aperture) capable of receiving zero-dimensional diffraction light or ±one-dimensional diffraction light in order to focus the image of a diffraction grating by means of an optical system as an image of the diffraction grating. Conversely, a space between in a modulator element inevitably forms a diffraction grating. Also a significantly small size of such a space with respect to the laser light also forms a diffraction grating. An optical system having a less significant NA, incapable of receiving the ±one-dimensional diffraction light but capable of receiving only positive reflected light can prevent each the modulator element of the spatial modulator device from being focused by reducing the resolution; thus, the unevenness caused by projecting the space between in the modulator element can be prevented. Also, preventing two-dimensional diffraction light or higher from being received may provide a similar effect depending in some conditions.

The NA of the optical system (lens 20) for introducing the indefinite light bundle laser light emitted by the spatial modulator device to the object lens should preferably satisfy ≦λ/P where P indicates a pitch of the modulator element of the spatial modulator device. In another expression, D should preferably be ≦2·L·λ/P where L indicates a focal distance of the lens 20 and D indicates an emitting pupil diameter of the lens 20.

Also, a condition indicating a defocused condition or a reduced NA and a conjugate relationship may be switchable if necessary.

Also, in the explanation of the first and third embodiment, an example using a plurality of micromirrors as a spatial modulator device was explained, a spatial modulator device used for a deflection optical element rotative around two axes may be a galvano mirror rotative around, for example, two axes.

Also, the spatial modulator device may be formed by combining such a galvano mirror and a one-dimensional or two-dimensional DMD.

Also, appropriate combinations of a plurality of components disclosed in the previous embodiments can provide various inventions. For example, some components may be deleted from all the components disclosed in the embodiments. Furthermore, components associated with different embodiments may be combined appropriately.

1-16. (canceled)

17. A repair method comprising:
emitting laser light output from a laser light source into a spatial modulator device having a plurality of modulator elements arranged in vertical and horizontal directions;
rectifying the cross-sectional shape of the laser light to the shape of an object to be repaired with the modulator elements by controlling the modulator elements of the spatial modulator device; and
repairing the repair object by illuminating the rectified laser light onto the repair object.

18. A repair method comprising:
extracting geometry data of an object to be repaired based on image data;
outputting laser light from a laser light source;
rectifying the laser light output from the laser light source to the shape of the repair object by controlling the modulator element of the spatial modulator device having each a plurality of modulator elements based on geometry data of the repair object; and
illuminating the laser light rectified by the modulator element to repair the repair object.

19. The repair method according to claim 17, wherein
the geometry data of the repair object is a difference image data or a geometry data indicative of a contour line of the repair object obtained by image-processing defect shape image data obtained by binarizing the difference image data,
the laser light is illuminated in the interior of the contour line of the repair object during repairing the repair object.

20. The repair method according to claim 17, further comprising:
positioning a substrate at a repair position based on inspection result data obtained from a substrate inspection apparatus that inspects the substrate having the repair object.

21. The repair method according to claim 20, further comprising:
calculating and determining as to whether a plurality of repair objects exist in the repairable region determined corresponding to the size of the spatial modulator device based on the inspection result data output from the substrate inspection apparatus.

22. The repair method according to claims 17, further comprising:
determining as to whether the repair object exists in the repairable region determined corresponding to the size of the spatial modulator device.

23. The repair method according to claim 1L7, wherein the modulator element corresponding to defect geometry data as the repair object is turned on among await the modulator element of the spatial modulator device.

24. The repair method according to claim 17, wherein the modulator element corresponding to non-defect geometry data as the repair object is turned on among the modulator element of the spatial modulator device.

25. The repair method according to claim 17, wherein the modulator element of the spatial modulator device is controlled again based on geometry data of a not-fully-repaired object if the repair object is not fully repaired, and the laser light is illuminated onto the not-fully-repaired object by the modulator element.

26. A repair apparatus comprising:
a laser light source for outputting laser light;
a spatial modulator device having a plurality of respectively controllable modulator elements arranged in vertical and horizontal directions;
an image-pickup apparatus for picking up an image of an object to be repaired;
a repair-object-extracting unit for extracting geometry data of the repair object from the image data obtained by the image-pickup apparatus;
a laser-shape-control unit for rectifying the laser light so as to conform to the shape of the repair object by the modulator elements by controlling the modulator elements of the spatial modulator device based on geometry data of the repair object extracted by the repair-object-extracting unit; and
an optical system for illuminating the laser light rectified by the modulator elements of the spatial modulator device onto the repair object.

27. The repair apparatus according to claim 26, wherein the image-pickup apparatus and the spatial modulator device are conjugate relative to the repair object.

28. The repair apparatus according to claim 26, wherein the spatial modulator device drives the modulator elements disposed in a region corresponding to geometry data of the repair object.

29. The repair apparatus according to claim 26, wherein the spatial modulator device drives the modulator elements disposed out of a region corresponding to geometry data of the repair object.

30. The repair apparatus according to 26, wherein
the repair-object-extracting unit extracts geometry data of the repair object indicative of defect repair from image data obtained by picking up an image of the image-pickup apparatus if the repair for the repair object was defective, and
the laser-shape-control unit controls the modulator elements of the spatial modulator device based on the geometry data of the repair object indicative of defect repair extracted by the repair-object-extracting unit.

31. The repair apparatus according to claim 26, further comprising:
a movement control unit for moving the repair object onto an optical axis of the image-pickup apparatus and the optical system, wherein
the image-pickup apparatus and the optical system are disposed on the optical axis commonly, and
the image-pickup apparatus moves relative to the optical system based on coordinate data of the repair object.

32. The repair apparatus according to claim 26, wherein
the spatial modulator device adapts an NA of the optical system for introducing light obtained from the spatial modulator device into the object lens to receive only positive reflected light.
